(19) United States
(12) Patent Application Publication
(10) Pub. No.: US 2010/0095596 A1
(43) Pub. Date: Apr. 22, 2010

(54) DOOR WITH MOTOR-OPERATED SLIDING PANEL FOR SHOWER BOOTHS

(75) Inventor: Raimondi LUCA, Bologna (IT)

Correspondence Address: EGBERT LAW OFFICES, 412 MAIN STREET, 7TH FLOOR, HOUSTON, TX, 77002, US

(73) Assignee: CALIBRE S.R.L., Monteveglio (BO) (IT)

(21) Appl. No.: 12/562,027

(22) Filed: Sep. 17, 2009

(30) Foreign Application Priority Data
Sep. 30, 2008 (IT) BO2008A000591

(51) Int. Cl. E05F 15/14

(52) U.S. Cl. 49/360

(57) ABSTRACT

The invention relates to a door with a sliding panel for shower booths. The door motor operates by a system including a driving gear housed inside an upright and an driven gear housed inside the other upright. A belt connects mechanically, being anchored to the sliding panel.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT Not applicable.

### INCORPORATION-BY-REFERENCE OF MATERIALS SUBMITTED ON A COMPACT DISC

Not applicable.

### BACKGROUND OF THE INVENTION

1. Field of the Invention

The present industrial invention relates to a sliding door for a shower booth, which, suitably motorized, allows the user to open and close the booth automatically simply by pressing a pushbutton.

2. Description of Related Art Including Information Disclosed Under 37 CFR 1.97 and 37 CFR 1.98.

With particular reference to the shower booths on the market today, the sliding door providing access thereto is operated solely by manual pushing, applied by degrees accordingly to achieve complete opening or closing of the booth.

### BRIEF SUMMARY OF THE INVENTION

The principal object of the present invention is to eliminate this drawback by devising a perfectly watertight motor-operated system for the panel which eliminates all technical elements exposed to view without altering the overall architecture of the booth.

This and other objects are achieved by the device according to the invention, which essentially consists of a fixed and a sliding panel, both of glass, comprised within a metal frame having functions as a guide for the mobile panel, which unlike present sliding panels is motor operated during opening and closing.

### BRIEF DESCRIPTION OF THE SEVERAL VIEWS OF THE DRAWINGS

These and other characteristics will now become more apparent in relation to a simple embodiment of the invention described for purely illustrative purposes, without limiting the scope of the present patent.

With reference to the appended drawings, FIG. 1 shows a perspective view of the door of the booth.

FIG. 2 and FIG. 3 are schematic views, showing the kinematic mechanism of movement of the sliding door.

FIG. 4 shows a partial perspective view of the motor system of the sliding door in detail.

FIG. 5 shows another partial perspective view of the driven gear of the transmission in detail.

FIG. 6 shows a perspective view of the inverter-controlled electric motor which actuates the driving gear.

FIG. 7 shows another perspective view of the driven gear connected to the driving gear by a belt, not illustrated in the figure.

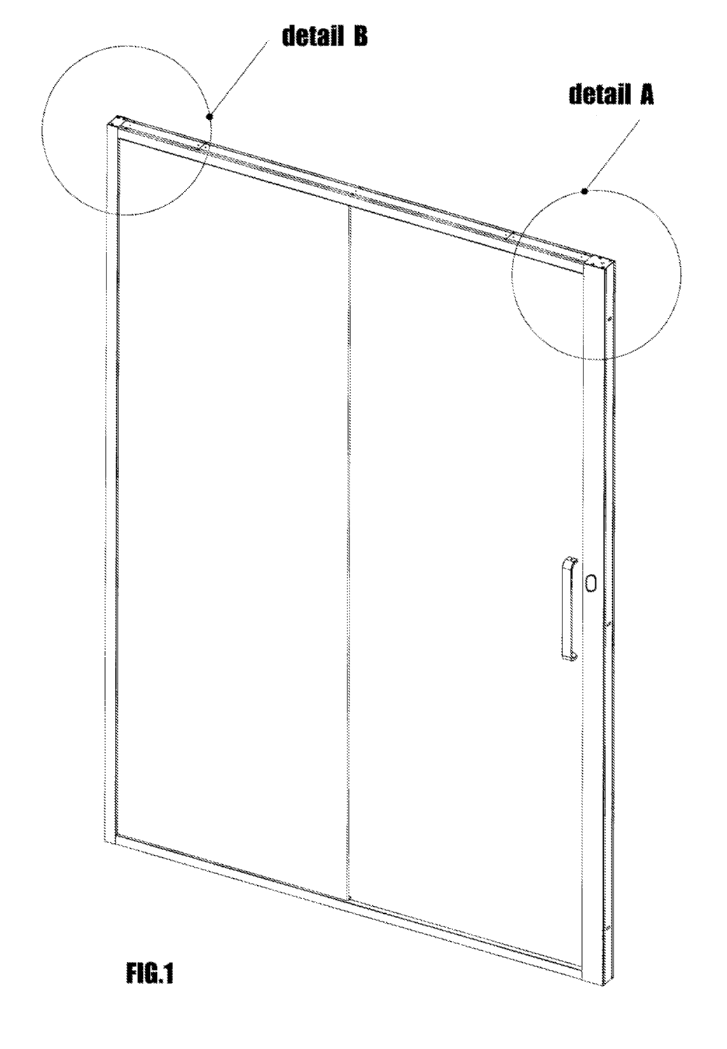

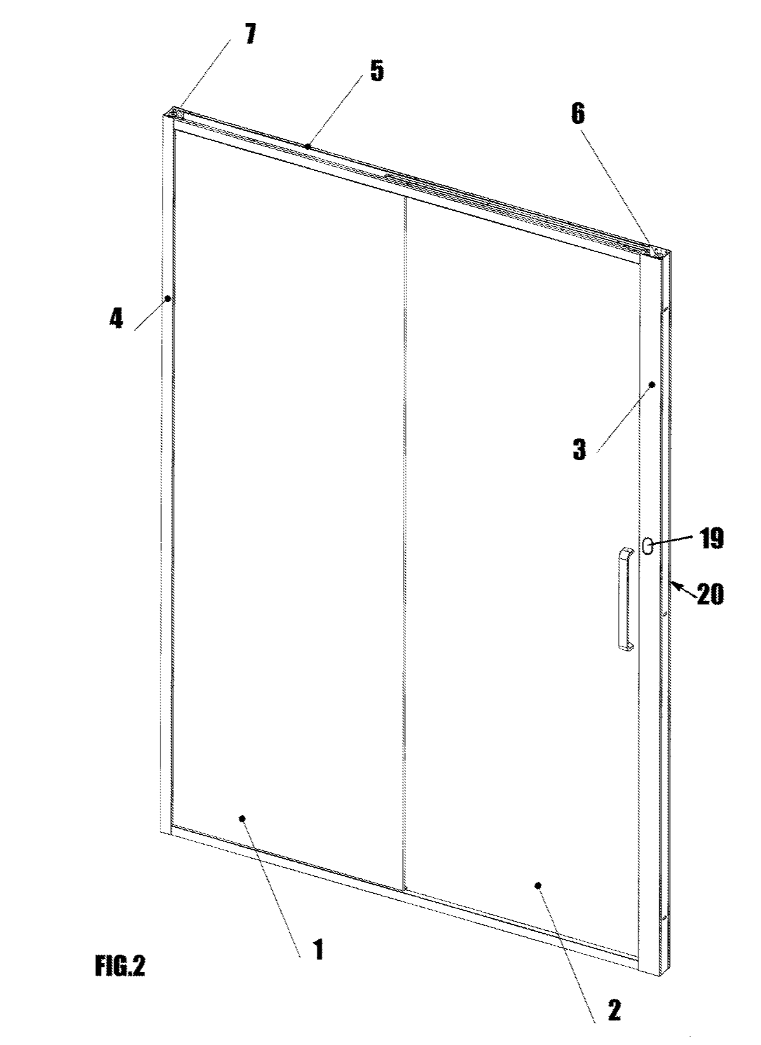

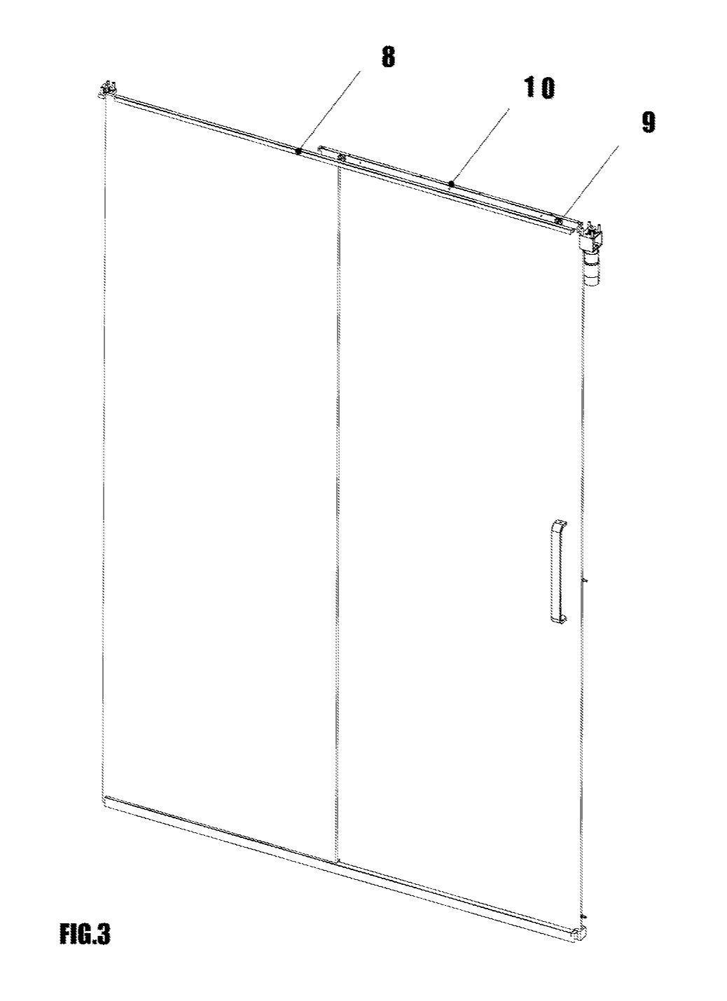

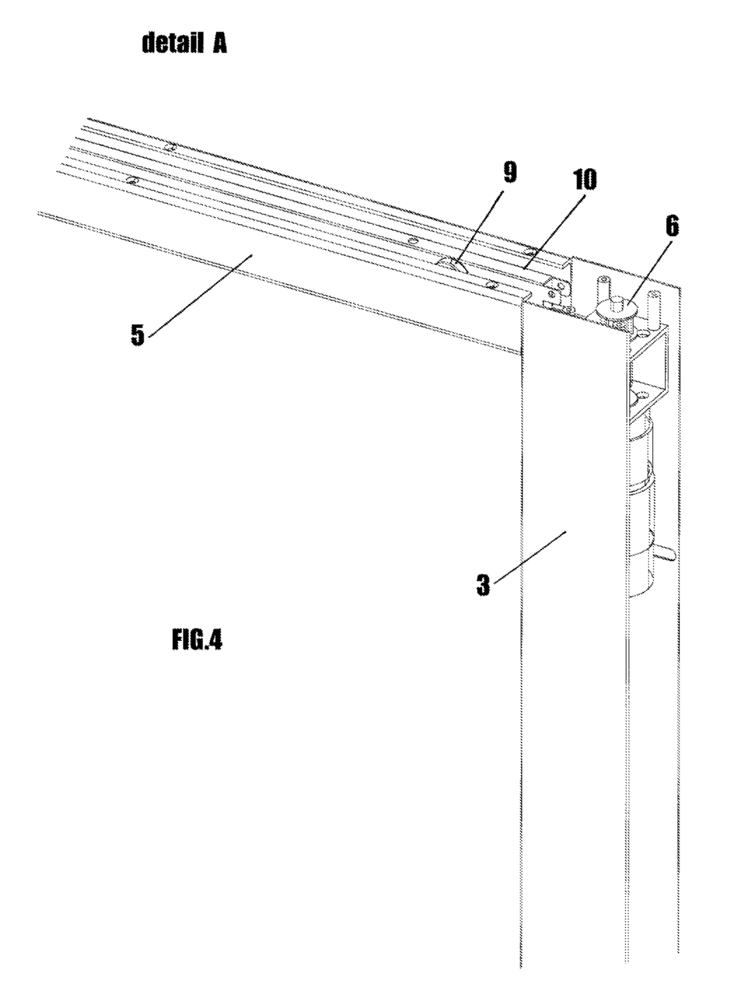

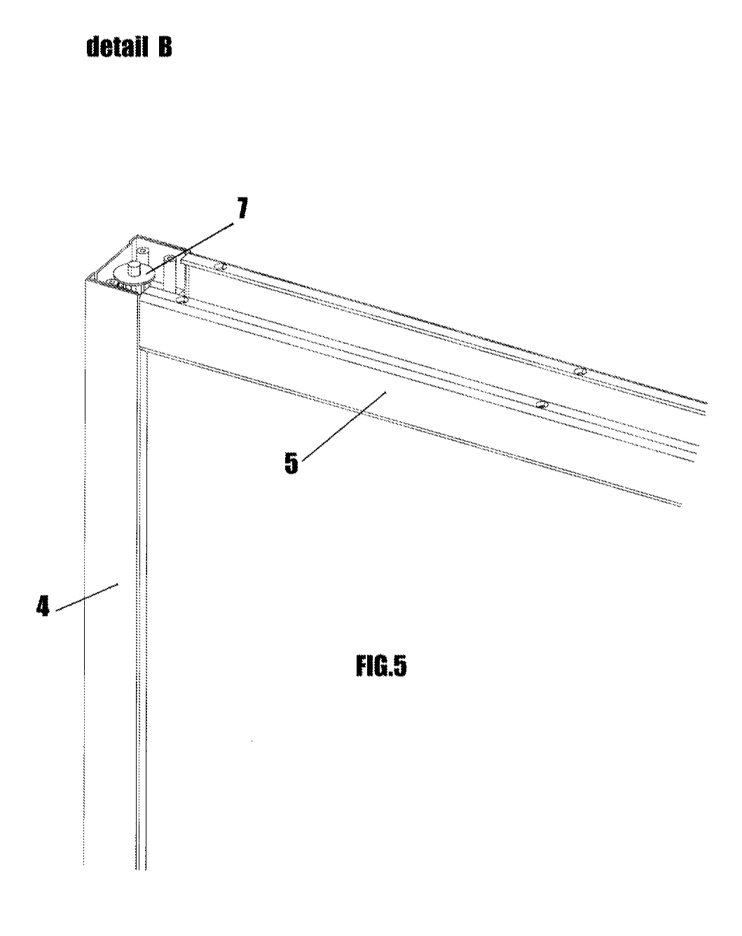

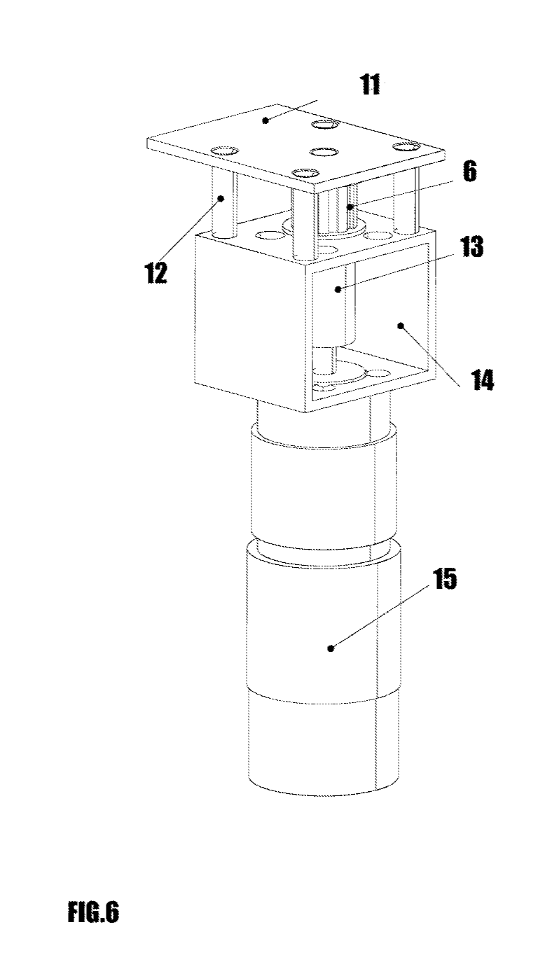

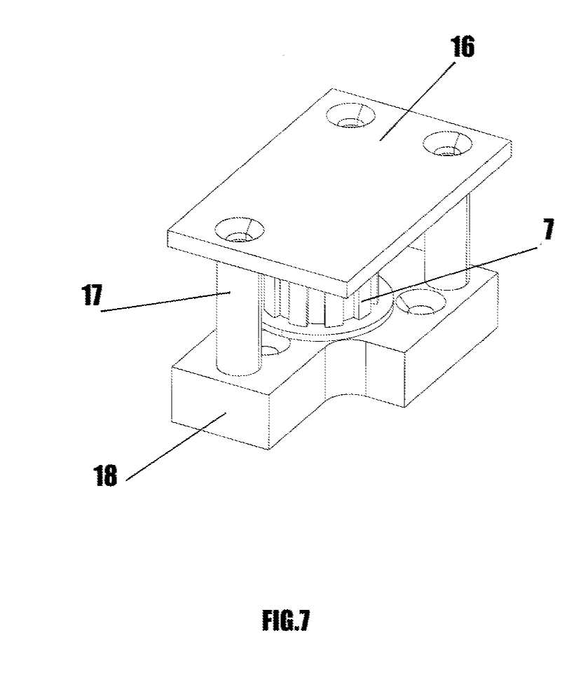

### DETAILED DESCRIPTION OF THE INVENTION

With reference to said figures, 1 indicates the fixed glass panel, 2 the mobile glass panel, 3 the large upright housing the motor, 4 the small upright, 5 the upper cross member, 6 the driving gear, 7 the driven gear, 8 the guide track for the bearings, and 9 and 10 the clamps securing the mobile glass panel (2). 11 indicated the cover for the gear (6), 12 welded rods, 13 a flexible coupling, 14 a fastening block, 15 the drive motor, 16 the cover for the driven gear (7), 17 the supporting rods and 18 the fastening plate. 19 indicates the outside control pushbutton and 20 the inside control pushbutton. The magnetically-operated relays for slowing down travel in both directions and the opening and closing limit stop relays of the mobile panel (2) are not illustrated. The drive belt anchored to the mobile panel by means of mechanical clamps insertable in the spaces of the belt itself and encompassing the thickness of the glass is likewise not illustrated in the appended drawings.

In practice the construction details, dimensions, materials, shape and other aspects of the invention may vary without departing from the scope of the present industrial patent. In fact, the invention thus conceived lends itself to numerous adaptations and variants, all falling within the realm of the inventive concept. In addition, all the elements may be replaced by other technically equivalent ones.

1. Door with motor-operated sliding panel for shower booths, the door comprising:
a fixed glass panel;
sliding glass panel;
a frame being comprised of an upper cross member and having a guide track;
bearings;
a glass clamp being inside; and
a lower cross member, the glass clamp and said lower cross member being connected by uprights, wherein each upright internally houses an electric motor actuated by pushbuttons via an electronic circuit card and directly drives the gear wheel, the gear wheel being connected to the driven gear of the upright by a timing belt forming a reverse drive circuit controlled by the travel limit relays, wherein the drive belt is anchored to the glass panel by a mechanical fastening system, being comprised of two or more clamps insertable in the spaces of the belt, encompassing the entire thickness of the glass, and wherein relays actuated by the passage of the glass panel across the electronic control circuit slaw down movement of the panel.

2. Door with motor-operated sliding panel for shower booths, according to claim 1, further comprising: a worm or a rack and pinion transmitting motion, wherein commands are sent by photocells as well as by pushbuttons.
